(19) United States
(12) Patent Application Publication
(10) Pub. No.: US 2022/0076183 A1
(43) Pub. Date: Mar. 10, 2022

(54) FACILITATING DECISION MARKING IN A BUSINESS PROCESS

(71) Applicant: International Business Machines Corporation, Armonk, NY (US)

(72) Inventors: Bu Yu Gao, Yinchuan (CN); Qi Cheng Li, Beijing (CN); Ya Bin Dang, Beijing (CN)

(21) Appl. No.: 17/015,225

(22) Filed: Sep. 9, 2020

(51) Int. Cl. G06Q 10/06; G06Q 10/10

(52) U.S. Cl. CPC G06Q 10/06375; G06Q 10/10

(57) ABSTRACT

Embodiments of the present disclosure relate to facilitating decision marking in a business process. In an embodiment, process execution data associated with execution of at least one instance of a business process are obtained. At least one first target attribute available at a first target point is determined based on the process execution data. The first target point is subsequent to a first decision point of a plurality of decision points in the business process, the at least one first target attribute has a contribution in deriving a first expected outcome at the first decision point, and the first target point is a first activity point or a first decision point. A suggestion is provided which suggests incorporating the at least one first target attribute in decision making at the first decision point executed in a further instance of the business process.

### BACKGROUND

The present disclosure generally relates to computer technologies and more particularly, to a method, system, and product for facilitating decision marking in a business process.

A business process is a set of logically related activity points requiring activities to be performed to achieve a business goal. A plurality of decision points or one final decision point is also involved in the business process to control the execution flows based on certain rules. Generally, a business process determines the nature of work within a business system and is typically defined by a set of workflows designed to achieve a goal of a business system. In real-world applications, both frequent changes of custom demands and the specialization of business processes require the capacity of modeling business processes effectively and efficiently.

### SUMMARY

In a first aspect of the present disclosure, there is provided a computer-implemented method. According to the method, process execution data associated with execution of at least one instance of a business process are obtained. The business process comprises a plurality of activity points and a plurality of decision points. At least one first target attribute available at a first target point is determined based on the process execution data. The first target point is subsequent to a first decision point of the plurality of decision points in the business process, the at least one first target attribute has a contribution in deriving a first expected outcome at the first decision point, and the first target point is a first activity point or a first decision point. A suggestion is provided which suggests incorporating the at least one first target attribute in decision making at the first decision point executed in a further instance of the business process.

In a second aspect of the present disclosure, there is provided a system. The system comprises a processing unit; and a memory coupled to the processing unit and storing instructions thereon. The instructions, when executed by the processing unit, perform acts of the method according to the first aspect of the present disclosure.

In a third aspect of the present disclosure, there is provided a computer program product being tangibly stored on a non-transient machine-readable medium and comprising machine-executable instructions. The instructions, when executed on a device, cause the device to perform acts of the method according to the first aspect of the present disclosure.

The above summary is not intended to describe each illustrated embodiment or every implementation of the present disclosure.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to some embodiments of the present disclosure.

FIG. 2 depicts a cloud computing environment according to some embodiments of the present disclosure.

FIG. 3 depicts abstraction model layers according to some embodiments of the present disclosure.

FIG. 4 depicts an example business process with multiple decision points.

FIG. 5 depicts a flowchart of an example process of facilitating decision marking in a business process implemented at a network device according to some embodiments of the present disclosure.

FIG. 6 depicts an example of attributes according to some embodiments of the present disclosure.

FIG. 7 depicts an example comparison table of different attributes used for decision making according to some embodiments of the present disclosure.

FIG. 8 depicts a flowchart of an example process of facilitating decision marking in a business process implemented at a network device according to some other embodiments of the present disclosure.

It should be appreciated that elements in the figures are illustrated for simplicity and clarity. Well-understood elements that may be useful or necessary in a commercially feasible embodiment may not be shown for the sake of simplicity and to aid in the understanding of the illustrated embodiments.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

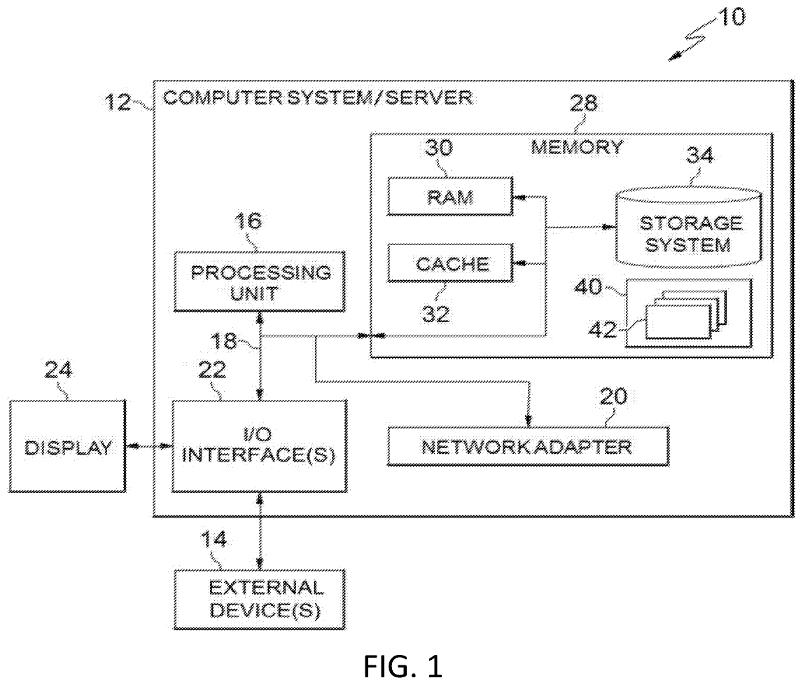

Referring now to FIG. 1, a schematic of an example of a cloud computing node is shown. Cloud computing node 10 is only one example of a suitable cloud computing node and is not intended to suggest any limitation as to the scope of use or functionality of embodiments described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors 16 (or processing units), a system memory 28, and a bus 18 that couples various system components including system memory 28 to the one or more processors 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of the present embodiments.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of the present embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

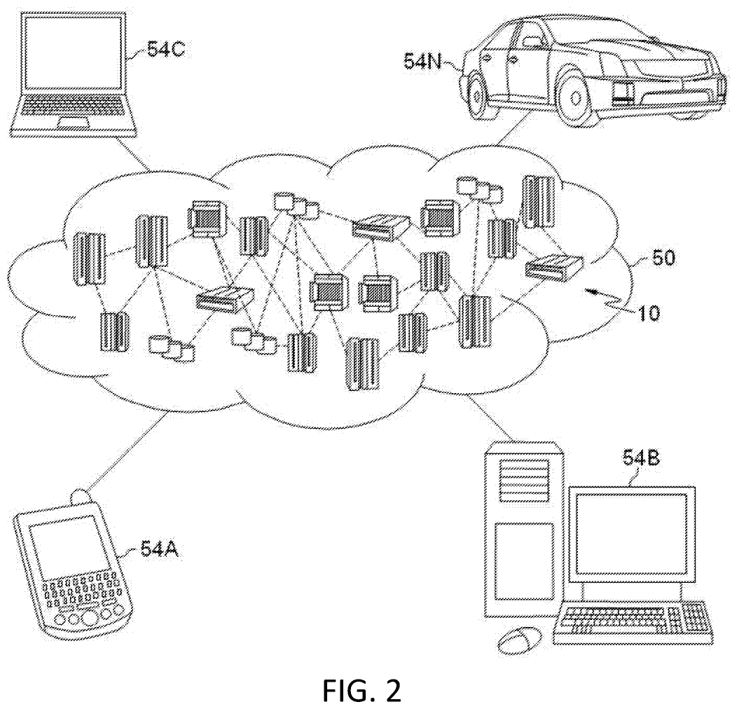

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

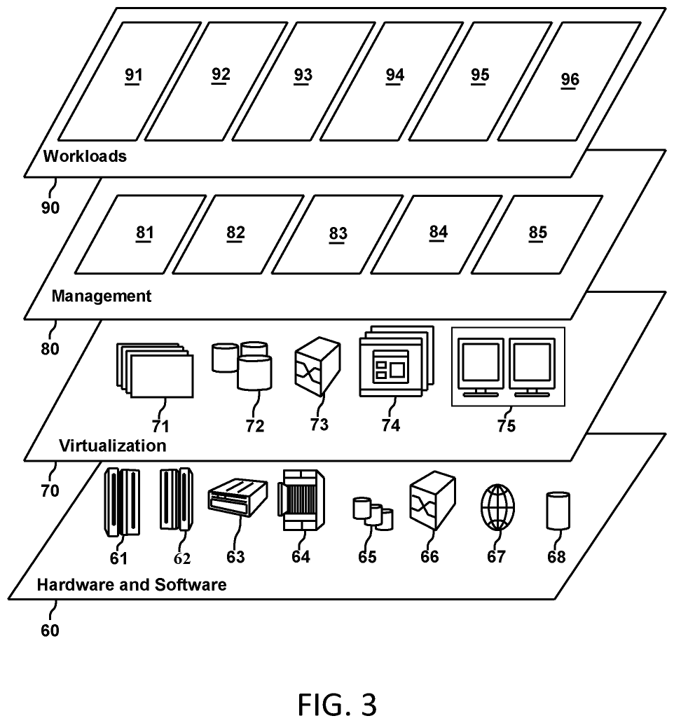

Referring now to FIG. 3, a set of functional abstraction layers provided by cloud computing environment 50 (FIG. 2) is shown. It should be understood in advance that the components, layers, and functions shown in FIG. 3 are intended to be illustrative only and the present embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and decision marking in a business process 96. The functionalities of decision marking in a business process 96 will be described in the following embodiments.

As mentioned above, in addition to activity points, a plurality of decision points or one final decision point may also be involved in a business process to control the workflow branches based on certain rules. A collection of points in a business process are linked together, where one activity point may lead to another activity point or a decision point, and a decision point may lead to a plurality of activity/decision points depending on outcomes made at this decision point. A decision point controls the execution flow among points in the business process based on a certain rule. The decision point may also be referred to as a gateway or a routing point.

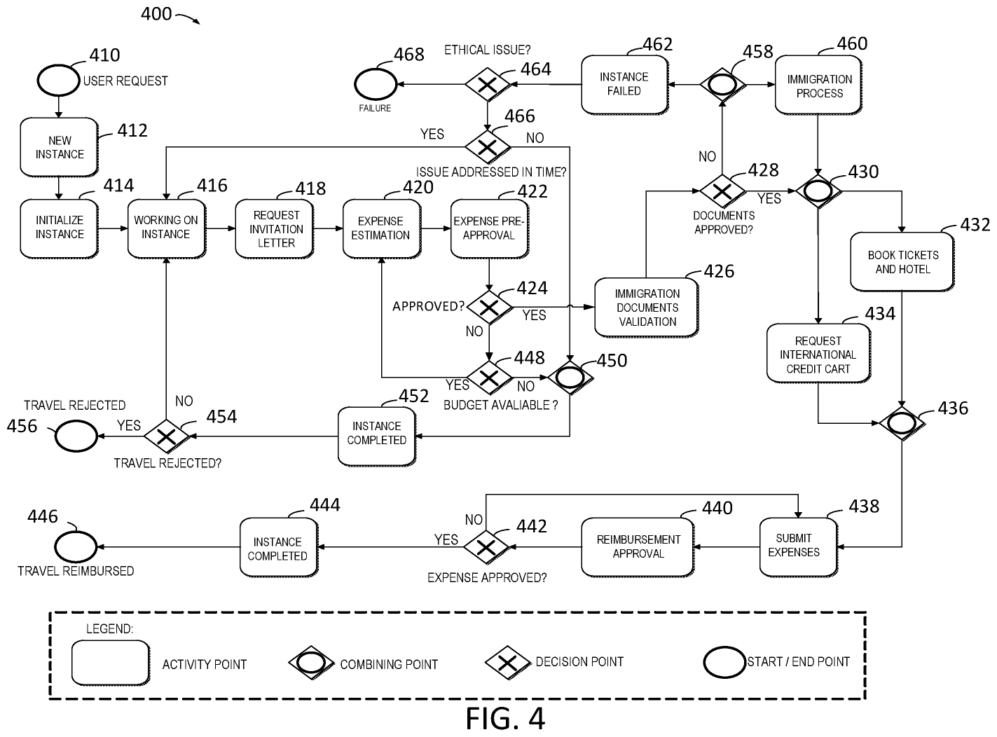

FIG. 4 illustrates an example business process 400 with multiple decision points. The business process 400 is related to a process of travel reimbursement approval. An end user provides a user request for reimbursement of travel expenses at a start point 410 of the business process 400, which initiates a new instance to be executed. As used herein, “an instance” of a business process represents a round of execution of this process.

As illustrated, the business process 400 comprises activity points 412, 414, 416, 418, 420, 422, 426, 432, 434, 438, 440, 442, 444, 452, 460, 462, each representing a specific activity to be performed. The activities in a business process may include, for example, information collection, account registration, event confirmation, and/or any other activities. The business process 400 also comprises decision points 424, 428, 442, 448, 454, 464, 466, each having more than one potential outcome. In the example of FIG. 4, the potential outcomes of each decision point include “yes” and “no” indicating whether a certain condition is met. It should be appreciated that a decision point in a business process may have other outcomes than the “yes” and “no” outcomes, such as classification results among a plurality of categories. The final outcome of the execution of an instance of the business process 400 may be “travel reimbursed” at an end point 446, “travel rejected” at an end point 456, and “failure” at an end point 468.

To execute an instance initiated by a user request, the execution of the activity points may involve information collection or other related activities. The decisions made at the decision points 422 may be manually checked, for example, by a knowledge worker (also referred to as a decision maker), or by using one or more automation tools.

It is noted that combining points 430, 436, 450, 458 in FIG. 4 are illustrated to combine links from different points to a same following point. The arrow of a link from a current point is directed to a point subsequent to the current point.

Due to the changeable rules and uncertain availability of information, it may be challenging to make an accurate decision for a decision maker, or to obtain a desired outcome for an end user. As compared with a business process with one final decision point, the business process with a plurality of decision points may be more complicated. In some cases, there may be some reworks or loops in execution of the business process due to different outcomes made at the decision points. For example, in the business process 400, the decision point 424 of deciding whether the expense can be approved may lead to rework of the activity point 420 “expense estimation” or the activity point 416 “working on case.”

For human decision makers, it is generally hard to make accurate and consistent decision with limited domain knowledge and expertise. Currently, there are provided some automation tools (e.g., prediction models) for making business process decisions in order to improve the efficiency of the decision making process. However, some complex and dynamic rules may not be captured in the automation tools.

It may be desirable to facilitate making accurate and desired decision at a decision point of a business process. According to some example embodiments of the present disclosure, there is provided such a solution to facilitate the decision marking. In this solution, process execution data associated with the execution of at least one instance of a business process are obtained and analyzed to determine one or more target attributes that are available at an activity point subsequent to a decision point in the business process. The target attribute(s) are determined to have a contribution in deriving an expected outcome at the first decision point. The determined target attribute(s) can be provided to decision making at the first decision point in a further instance of the business process.

Through this solution, by mining more available attributes from subsequent activity points for a decision point, it is possible to help the end users to get explainable recommendations and automation of decision in the process so they can figure out how to obtain a desired result. The attributes from subsequent activity points may also assist a decision maker in mining dynamic rules during the business process, which may improve the accuracy of the decision.

Example embodiments of the present disclosure will be described in detail below with reference to the accompanying drawings.

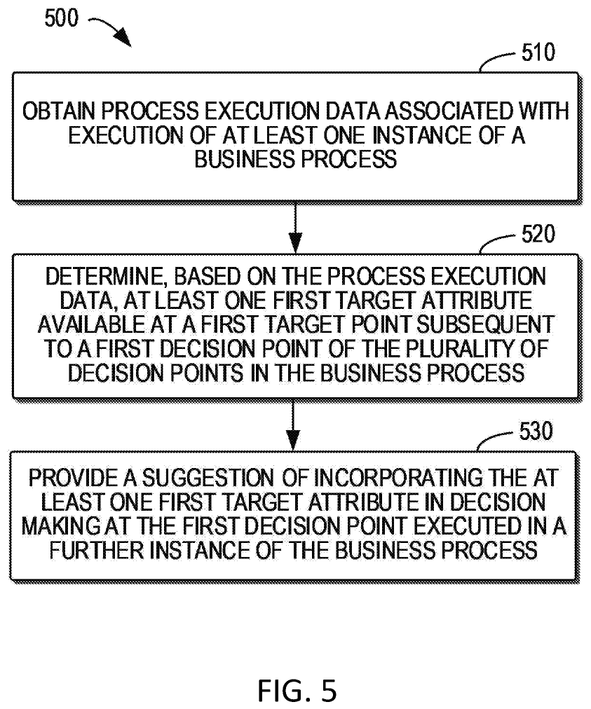

Reference is now made to FIG. 5, which shows a flowchart of a process 500 for facilitating decision marking in a business process implemented at a network device according to some embodiments of the present disclosure. The process 500 may be implemented by the computer system/server 12 of FIG. 1.

At block 510, the computer system/server 12 obtains process execution data associated with execution of at least one instance of a business process.

A business process is a set of logically related activities and decisions performed to achieve a business outcome or goal. The business process is represented as a set of linked points, including a plurality of activity points and a plurality of decision points.

In general, a business process determines the nature of work within a business system and is typically defined by a set of workflows designed to achieve a goal of a business system. Examples of business processes within business systems may include expense reimbursement, insurance compensation, determining a risk class for a life insurance application, determining how to allocate a payment to different customer accounts or providing a quote for leasing equipment or vehicles.

The activities and outcomes at respective decision points may be varied depending on the actual business processes. In the following, reference will be made to the business process 400 shown in FIG. 4 for the purpose of better understanding the embodiments of the present disclosure. It should be appreciated that the business process 400 is merely an example for illustration only, without suggesting any limitation to the present disclosure. The embodiments described herein can be applied to any other business process.

The process execution data are historical data that are collected from historical execution of any instance of the business process. The process execution data may comprise any collectable data related to execution of the one or more instances of the business process. In some embodiments, more instances of the business process considered may result in more accurate results for mining attributes contributed to a decision point.

In some embodiments, the process execution data may be determined from raw data generated in execution of the instance(s) of the business process, such as event logs, summaries, time series data, collected information, and/or the like. The event log or time series data may indicate the time when an activity at an activity point, the time when a decision is made, the outcome of the decision point, activity data used in performing the activity, decision data considered in making a certain outcome, and so on. In some embodiments, the raw data may be processed in order to filter more useful and meaningful data for use.

At block 520, the computer system/server 12 determines, based on the process execution data, at least one target attribute (referred to as a “first target attribute”) available at a target point (referred to as a “first target point”) subsequent to a decision point (referred to as a “first decision point”) in the business process. The at least one first target attribute is determined to have a contribution in deriving an expected outcome (referred to as a “first expected outcome”) at the first decision point. The first target point may be an activity point or a decision point. The first decision point may be any decision point that has one or more subsequent points in the business process.

Traditionally, the decision marking at each decision point is generally based on information currently available at the respective point, which may lead to inaccurate decisions or a rework in the business process. In accordance with embodiments of the present disclosure, by mining the process execution data from historical execution of the business process, it is possible to find more target attribute(s) that also contribute to deriving an expected outcome at a certain decision point. The target attribute(s) comes from a point subsequent to the certain decision point which is not used to generate an outcome at this decision point.

In a business process with a plurality of decision points, attributes at following points may have an impact on the decision making in the current decision point in many cases and thus are important for decision making at the decision point. In the case that decision making at a decision point is performed by a prediction model, the greater the number of attributes that are considered at a current decision point may lead to higher accuracies in the decision making process.

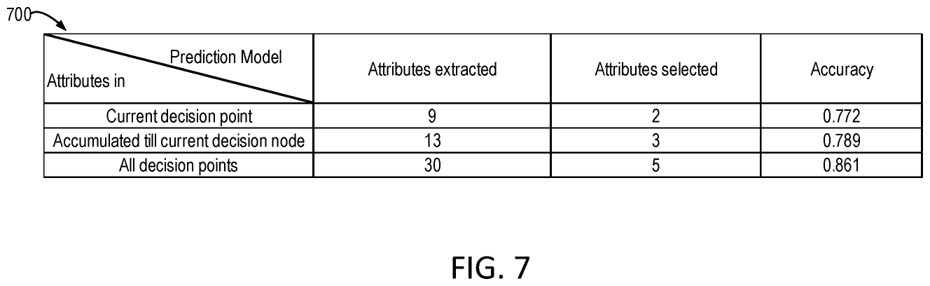

FIG. 7 shows an example of a comparison table 700 indicating different accuracy levels obtained when different attributes are used in making the decision in the prediction model. The first row in the comparison table 700 indicates a first case where attributes are extracted only from information collected at the current decision point, the second row indicates a second case where attributes from the preceding points to the current decision point in the business process are all extracted for making the decision, and the third row indicates a third case where attributes from the preceding points to the subsequent points of the current decision point are all extracted for making the decision. The second column “Attributes extracted” indicates the number of attributes available, the third column “Attributes selected” indicates the number of attributes that are determined to be significant and selected for making the decision, and the third row indicates accuracies in the three cases. As can be seen, with the addition of the subsequent points, more attributes are selected as being significant to the decision making and the accuracy also increases.

As a specific example, in the business process 400 of FIG. 4, due to a lack of detailed information explaining the expense, in an instance of the business process 400, the expense for the travel reimbursement is not approved at the decision point 424. It is found that if additional information about tickets and hotels that are available at the activity point 432 “book tickets and hotel” may facilitate the expense to be approved at the decision point 424 because the additional information may indicate why the expense is higher than expected.

In order to find the target attribute(s) that contributes to the decision making at a certain first decision point, the computer system/server 12 may extract and analyze attributes available at some or all of the subsequent points. The attribute(s) available at a point may indicate a certain characteristic or feature extracted from execution data related to this point (activity or decision). The execution data may include information collected for execution at this point, metadata of the execution process, and/or any other characteristic or feature that can be used to describe the execution or information collected at this point.

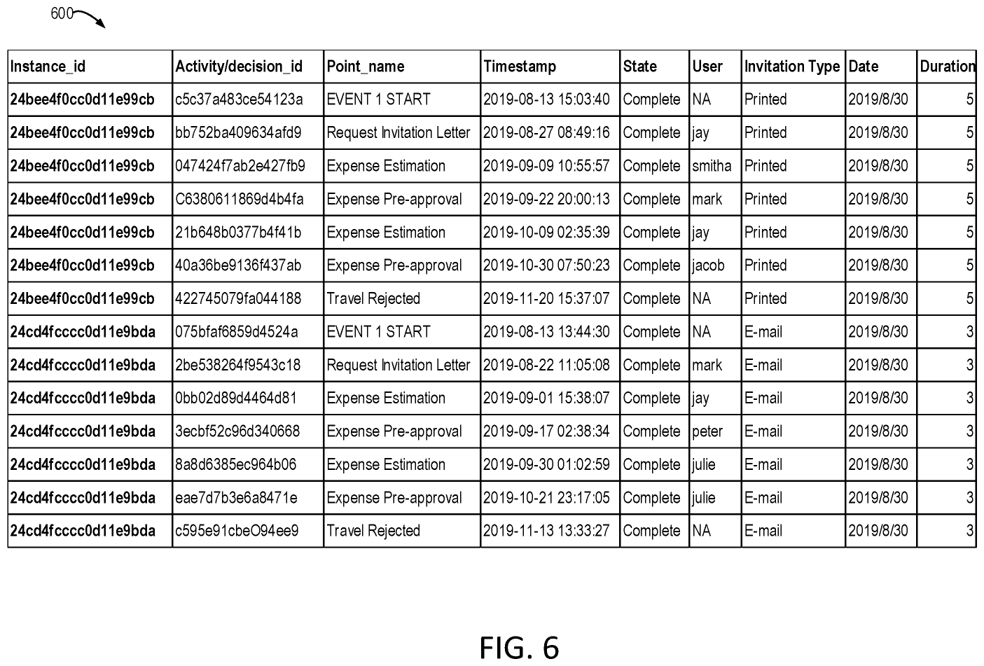

The attributes may have various types, including numeric attributes, categorical attributes, date, time, and/or others. Examples of the attributes available at a point of the business process may include time, an execution result, an execution time, an actor executing the activity or making the decision, one or more features exacted from the collected information (such as documents, letters, tickets, orders, and the like), and/or the like. FIG. 6 depicts a specific example of attributes according to some embodiments of the present disclosure. The attributes are organized into structured data 600 which comprises a plurality of data entries (corresponding to rows in FIG. 6) recording attributes related to some points in two instances of the business process 400. The example attributes comprises the execution time (the timestamp and date), the state of the execution, the user performed or initiated the execution, the invitation type, and the duration.

In some embodiments, for a certain first decision point in the business process, the computer system/server 12 may identify a plurality of attributes available at each subsequent point from execution data related to the subsequent point. The computer system/server 12 may further determine, based on execution data related to the first decision point, respective measures of contribution of the plurality of attributes in deriving the first expected outcome at the first decision point. The execution data related to the first decision point include information collected for execution at this point, metadata of the execution process, and/or any other characteristic or feature that can be used to describe the execution or information collected at this point. The execution data specifically includes outcomes provided at the first decision point in each instance of the business process.

To determine a measure of contribution of a certain attribute, the computer system/server 12 may determine a first confidence score of obtaining the first expected outcome at the first decision point without considering the attribute, and a second confidence score of obtaining the first expected outcome at the decision point with the attribute considered together with current attributes considered at the first decision point. The computer system/server 12 may build a prediction model to perform the decision making at the first decision point to generate the confidence scores, or it may require manual decision making in each case.

The measure of contribution may be determined based on a difference between the first and second confidence scores. If the difference indicates an increase from the first confidence score to the second confidence score, the measure of contribution may indicate a positive contribution. Otherwise, the measure of contribution may indicate a negative contribution. The higher the increase is, the higher the measure of contribution is.

With the respective measures of contribution of the plurality of attributes determined, the computer system/server 12 may compare the respective measures of contribution with a predetermined contribution threshold. If any of the respective measures of contribution exceeds the contribution threshold, the computer system/server 12 may select the attribute with the measure of contribution exceeding the contribution threshold as a target attribute, and the corresponding subsequent point is a target point.

In some embodiments, any decision point that has one or more subsequent points in the business process can be considered as a “first decision point.” Then one or more attributes available at a subsequent point(s) of this first decision point may be evaluated to find if any of the attributes can have a certain contribution in making a decision(s) about one or more outcomes. As a result, the computer system/server 12 may determine one or more target attributes for one or more decision points in the business process.

The target attribute(s) from the target point(s) subsequent to a decision point may help facilitate the decision making Referring back to FIG. 5, at block 530, the computer system/server 12 provides a suggestion of incorporating the at least one first target attribute in decision making at the first decision point executed in a further instance of the business process.

As the at least one first target attribute is determined from the historical process execution data as having a contribution in deriving a first expected outcome at the first decision point, the computer system/server 12 provides a suggestion to indicate that such first target attribute(s) can be used in decision making at this decision point.

In some embodiments, in evaluating the contributions of the attributes available at a subsequent point to the first decision point, the “first expected outcome” at the first decision point may be any one of the possible outcomes at the first decision point. That is, the attributes at the subsequent point are evaluated to find significant target attributes for each possible outcome. This can help the decision maker (or the owner of the business process) learn which attributes additionally contribute more to the decision making In some embodiments, the “first expected outcome” at a decision point may be a preferred outcome for an end user among all the possible outcomes. For example, in an approval business process, the preferred outcome at any decision point may be the one that leads to a final outcome of approval without additional rework at the activity points.

In some embodiments, the computer system/server 12 may present a suggestion or recommendation of provisioning the at least one first target attribute at the first decision point by a user. This suggestion may be presented to an end user or a decision maker. For example, in the business process 400, if an end user initiating an instance of the business process 400 fails to get approval of his/her expense at the decision point 424, he/she may want to figure out the reason. According to some embodiments of the present disclosure, if it is determined that additional information about tickets and hotels at the activity point 432 “book tickets and hotel” may facilitate a “yes” outcome of approving the expense at the decision point 424, the computer system/server 12 may present a suggestion to the end user, to recommend he/she providing the additional information at the current decision point, although such additional information should be submitted in the subsequent activity point 432.

In some embodiments, if a first prediction model that is used for generating an outcome at the first decision point, the computer system/server 12 may provide a suggestion or recommendation of adding the at least one first target attribute as an input to the first prediction model. This suggestion or recommendation may be presented to a business owner or an administrator of the business process. In some embodiments, the second suggestion may be automatically adopted in a system for generating and updating the first prediction model.

In some embodiments, in addition to the at least one first target attribute, a measure of contribution to the expected outcome may also be provided in the corresponding suggestion. In some embodiments, if target attributes at subsequent points contributing to a plurality of outcomes at the first decision point are determined, the suggestion may indicate all the target attributes and the outcomes to which the target attributes contribute.

In some embodiments, some attributes having adjustable values may also be important in determining different outcomes at a decision point of the business process. If an inappropriate value is set for an attribute at a point, the following decision point may produce an undesired outcome, which may lead to rework or loops between decision points or may lead to an unacceptable duration or a low processing efficiency to get an outcome at a decision point. Therefore, identifying such attributes and their value ranges may help facilitate the decision making

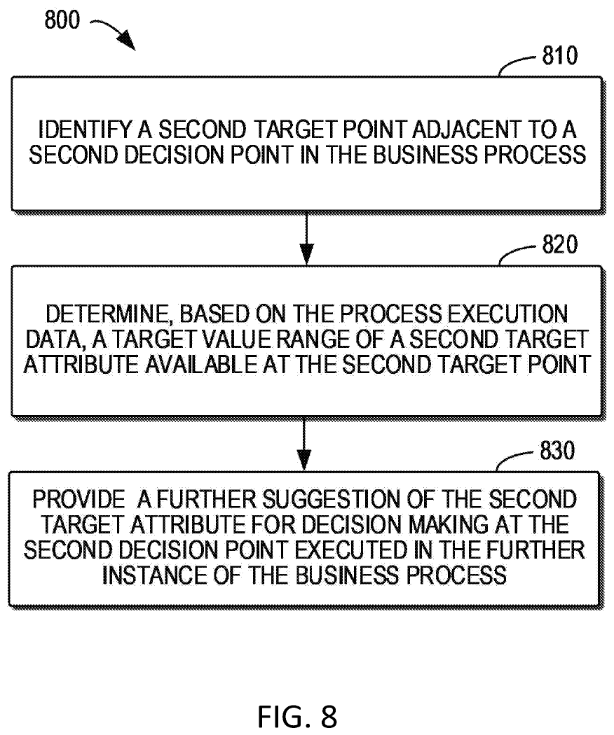

Reference is now made to FIG. 8, which shows a flowchart of a process 800 for facilitating decision marking in a business process implemented at a network device according to some embodiments of the present disclosure. The process 800 may be implemented by the computer system/server 12 of FIG. 1.

At block 810, the computer system/server 12 identifies a target point (referred to as “second target point”) adjacent to a decision point (referred to as “second decision point”) in the business process.

The second decision point may be any decision point in the business process that has one or more adjacent or neighbor points. The second decision point may be the same as or different from the above mentioned first decision point. In some embodiments, the second decision point may be a decision point having at least one outcome directed to a point preceding the second decision point in the business process. As such, an execution flow directed by the outcome(s) may result in a rework or a loop in the business process. In the example business process 400, the decision point 424 has a “no” outcome of failing to be approved, which may be directed to the activity point 420 through the decision point 448. Thus, the decision point 424 may be considered as a second decision point. Other decision points 428, 442, 448, 454, 464, 466 may also have respective outcomes that may lead to reworks or loops in the business process. Thus, those decision points may each be selected as a second decision point. The process 800 may be performed for each of such decision points.

As will be described below, the second target point has an attribute with a target value range that contributes to deriving an expected outcome (referred to as “second expected outcome”) at the second decision point. In order to reduce the search space for the target value range, the computer system/server 12 may identify the second target point around the second decision point. The second target point may have at least one attribute that can be valued from a certain range. This range may include continuous values or a set of discrete values. In some embodiments, the second target point may be selected at an activity point or decision point preceding the second decision point.

In some embodiments, the second target point may have a short distance to the second decision point. A distance between two points in a business process may be measured by the number of points along a path from one point to the other point. If more than one path exists, the distance may be measured using the shortest path. In an embodiment, if a distance from the second decision point to a point in the business process is below a distance threshold, this point may be determined as the second target point. Generally, values of attributes at a point far from a decision point may have little contribution to the decision making at the decision point. By eliminating the points using the distance, the following filtering computation can be reduced.

In some embodiments, all possible values of any attribute available at a point may be extracted from execution data related to this point. This part of execution data is comprised in the process execution data obtained from execution of one or more instances of the business process. If an overall value range covering all the possible values is greater than a range threshold, it means that there are a large number of possible values selectable for the attribute. In such case, it may be more important to identify a sub-range that contributes more to an outcome at a decision point. Therefore, in some embodiments, as an alternative to (or in addition to) the distance, the second target point may be selected as having an overall value range greater than the range threshold. In some embodiments, one or more second target points may be selected for a second decision point.

At block 820, the computer system/server 12 determines, based on the process execution data, a target value range of a target attribute (referred to as “second target attribute”) available at the second target point, the second target value range having a contribution in deriving a second expected outcome at the second decision point. The contribution of the second target value range indicates that the second target value range has a stronger correlation with the second expected outcome as compared with other possible value range(s) for the second target attribute.

From execution data comprised in the process execution data and related to the second target point, one or more attributes available at the second target point may be extracted, similarly to the extraction of the attributes available at the first target point described above. The values of all the attributes available at the second target point may also be extracted from the execution data.

In some embodiments, the computer system/server 12 may further determine, based on execution data related to the second decision point, respective measures of contribution of the plurality of value ranges in deriving the second expected outcome at the second decision point. The execution data related to the second decision point include information collected for execution at this point, metadata of the execution process, and/or any other characteristic or feature that can be used to describe the execution or information collected at this point. The execution data specifically includes outcomes provided at the second decision point in each instance of the business process.

To determine a measure of contribution of a certain value range, the computer system/server 12 may determine respective confidence scores of obtaining the second expected outcome at the second decision point when the second target attribute is set to respective values in the value range, and determine an overall confidence score for this value range based on the respective confidence scores, as the measure of contribution. In some embodiments, the computer system/server 12 may first determine a confidence score for each possible value in an overall value range of the second target attribute, and then divide the overall value range into a plurality of value ranges based on the respective confidence scores. The overall confidence score for each value range may be determined accordingly, as the measure of contribution. The computer system/server 12 may build a prediction model to perform the decision making at the second decision point to generate the confidence scores, or it may require manual decision making in each case. In either way, a value range for the second target attribute and its measure of contribution to the second expected outcome.

In the business process 400 in FIG. 4, the computer system/server 12 may determine that an attribute of “expense” available at the activity point 420 may be set with costs in different cost ranges. After measuring the contributions of the different cost ranges to the “yes” outcome at the decision point 424, the computer system/server 12 may determine that a cost range of “<3000 USD” has a significant contribution to the “yes” outcome at the decision point 424.

With the respective measures of contribution of the plurality of value ranges determined, the computer system/server 12 may compare the respective measures of contribution with a further contribution threshold. If any of the respective measures of contribution exceeds the further contribution threshold, the computer system/server 12 may select the value range with the measure of contribution exceeding the contribution threshold as a target value range for the second target point.

In some embodiments, in evaluating the contributions of the attributes available at a subsequent point to the first decision point, the “second expected outcome” at the second decision point may be any one of the possible outcomes at the second decision point. That is, all value ranges of the second target attributes are evaluated to find significant value range for each possible outcome. This can help the decision maker (or the owner of the business process) learn which value ranges contribute more to one of the outcomes at the decision making In some embodiments, the “second expected outcome” at a decision point may be a preferred outcome for an end user among all the possible outcomes. For example, in an approval business process, the preferred outcome at any decision point may be the one that leads to a final outcome of approval without additional rework at the activity points.

As the target value range is determined from the historical process execution data as having a contribution in deriving the second expected outcome at the first decision point, at block 830, the computer system/server 12 provides a further suggestion of the second target attribute for decision making at the second decision point executed in the further instance of the business process.

In some embodiments, the computer system/server 12 may present a suggestion or recommendation of setting a value falling within the target value range for the second target attribute at the second target point by a user. This suggestion may be presented to an end user or a decision maker. For example, in the business process 400, if an end user initiating an instance of the business process 400 fails to get approval of his/her expense at the decision point 424, he/she may want to figure out the reason. According to some embodiments of the present disclosure, if it is determined that a cost range of “<3000 USD” has a significant contribution to the “yes” outcome at the decision point 424, the computer system/server 12 may present a suggestion to the end user, to recommend he/she changing the expense to be a value within the cost range of “<3000 USD,” which can improve the confidence of obtaining the “yes” outcome at the decision point 424.

In some embodiments, if a second prediction model that is used for generating an outcome at the second decision point, the computer system/server 12 may provide a suggestion or recommendation indicating an increase of a weight assigned to the second target attribute in a second prediction model. This suggestion or recommendation may be presented to a business owner or an administrator of the business process. In some embodiments, the second suggestion may be automatically adopted in a system for generating and updating the second prediction model. By assigning a higher weight to the second target attribute, the second prediction model can generate more accurate outcomes at the second decision point based on the values set for the second target attribute.

In some embodiments, the computer system/server 12 may evaluate the range values of a plurality of attributes at one or more target points and may determine respective target range values of the plurality of attributes that contribute significantly to a specific outcome at the second decision point, or to all the possible outcomes at the second decision points. A list of the respective target range values together with the associated outcome(s) of the second decision point may also be suggested or recommended.

In some embodiments, if a cost model (e.g. a time cost model, which can be defined by the process owner) is available to measure the cost of obtaining a value in the target value range, to keep a good balance between the confidence and adjusting cost, the cost information may also be included in the suggestion.

While operations of the method are depicted in a particular order, it should not be understood as requiring that such operations are performed in the particular order as shown in a sequential order, or that all illustrated operations be performed, to achieve desirable results. In certain circumstances, multitasking and parallel processing may be advantageous.

It should be noted that the processing of facilitating decision marking in a business process according to embodiments of this disclosure could be implemented by the computer system/server 12 of FIG. 1. The described functionalities facilitating decision marking in a business process may be implemented with corresponding components in computer system/server 12, which may be implemented in hardware, software, firmware, or a combination thereof.

The present embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present disclosure are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by one or more processors, process execution data associated with execution of at least one instance of a business process, the business process comprising a plurality of activity points and a plurality of decision points;
determining, by one or more processors and based on the process execution data, at least one first target attribute available at a first target point subsequent to a first decision point of the plurality of decision points in the business process, the at least one first target attribute having a contribution in deriving a first expected outcome at the first decision point, and the first target point being a first activity point or a first decision point; and
providing, by one or more processors, a suggestion of incorporating the at least one first target attribute in decision making at the first decision point executed in a further instance of the business process.

2. The method of claim 1, wherein the process execution data comprises first execution data related to the first target point and second execution data related to the first decision point, and wherein determining the at least one first target attribute comprises:
identifying, by one or more processors, a plurality of attributes available at the first target point from the first execution data;
determining, by one or more processors, respective measures of contribution of the plurality of attributes in deriving the first expected outcome based on the second execution data; and
selecting, by one or more processors and from the plurality of attributes, at least one attribute having a measure of contribution exceeding a contribution threshold as the at least one first target attribute.

3. The method of claim 1, wherein providing the suggestion of incorporating the at least one first target attribute comprises performing at least one of the following:
providing, by one or more processors, a first suggestion of provisioning the at least one first target attribute at the first decision point by a user; and
providing, by one or more processors, a second suggestion of adding the at least one first target attribute as an input to a first prediction model, the first prediction model being used for generating an outcome at the first decision point.

4. The method of claim 1, further comprising:
identifying, by one or more processors, a second target point adjacent to a second decision point in the business process, the second target point being a second activity point or a second decision point;
determining, by one or more processors, a target value range of a second target attribute available at the second target point based on the process execution data, the second target value range having a contribution in deriving a second expected outcome at the second decision point; and
providing, by one or more processors, a further suggestion of the second target attribute for decision making at the second decision point executed in the further instance of the business process.

5. The method of claim 4, wherein the second decision point has at least one outcome directed to a point preceding the second decision point in the business process.

6. The method of claim 4, wherein identifying the second target point comprises identifying, by one or more processors, a point from the business process that satisfies at least one of the following conditions as the second target point:
a distance from the second decision point to the second target point being below a distance threshold;
an overall value range of an attribute available at the second target point being greater than a range threshold; and
the second target point preceding the second decision point in the business process.

7. The method of claim 4, wherein the process execution data comprises third execution data related to the second target point and fourth execution data related to the second decision point, and wherein determining the target value range comprises:
determining, by one or more processors, a plurality of value ranges of the second target attribute based on the third execution data;
determining, by one or more processors and based on the decision data, respective measures of contribution of the plurality of value ranges in deriving the second expected outcome; and
selecting, by one or more processors and from the plurality of value ranges, the target value range having a measure of contribution exceeding a further contribution threshold.

8. The method of claim 4, wherein determining the target value range comprises:
providing, by one or more processors, a third suggestion of setting a value falling within the target value range for the second target attribute at the second target point by a user; and
providing, by one or more processors, a fourth suggestion indicating an increase of a weight assigned to the second target attribute in a second prediction model, the second prediction model being used for generating an outcome at the second decision point.

9. A system comprising:
one or more computer readable storage media with program instructions collectively stored on the one or more computer readable storage media; and
one or more processors configured to execute the program instructions to perform a method comprising:
obtaining process execution data associated with execution of at least one instance of a business process, the business process comprising a plurality of activity points and a plurality of decision points;
determining, based on the process execution data, at least one first target attribute available at a first target point subsequent to a first decision point of the plurality of decision points in the business process, the at least one first target attribute having a contribution in deriving a first expected outcome at the first decision point, and the first target point being a first activity point or a first decision point; and
providing a suggestion of incorporating the at least one first target attribute in decision making at the first decision point executed in a further instance of the business process.

10. The system of claim 9, wherein the process execution data comprises first execution data related to the first target point and second execution data related to the first decision point, and wherein determining the at least one first target attribute comprises:
identifying, from the first execution data, a plurality of attributes available at the first target point;
determining, based on the second execution data, respective measures of contribution of the plurality of attributes in deriving the first expected outcome; and
selecting, from the plurality of attributes, at least one attribute having a measure of contribution exceeding a contribution threshold as the at least one first target attribute.

11. The system of claim 9, wherein providing the suggestion of incorporating the at least one first target attribute comprises performing at least one of the following:
providing a first suggestion of provisioning the at least one first target attribute at the first decision point by a user; and
providing a second suggestion of adding the at least one first target attribute as an input to a first prediction model, the first prediction model being used for generating an outcome at the first decision point.

12. The system of claim 9, wherein the methods further comprise:
identifying a second target point adjacent to a second decision point in the business process, the second target point being a second activity point or a second decision point;
determining, based on the process execution data, a target value range of a second target attribute available at the second target point, the second target value range having a contribution in deriving a second expected outcome at the second decision point; and
providing a further suggestion of the second target attribute for decision making at the second decision point executed in the further instance of the business process.

13. The system of claim 12, wherein the second decision point has at least one outcome directed to a point preceding the second decision point in the business process.

14. The system of claim 12, wherein identifying the second target point comprises identifying a point from the business process that satisfies at least one of the following conditions as the second target point:
a distance from the second decision point to the second target point being below a distance threshold;
an overall value range of an attribute available at the second target point being greater than a range threshold; and
the second target point preceding the second decision point in the business process.

15. The system of claim 12, wherein the process execution data comprises third execution data related to the second target point and fourth execution data related to the second decision point, and wherein determining the target value range comprises:
determining a plurality of value ranges of the second target attribute based on the third execution data;
determining, based on the decision data, respective measures of contribution of the plurality of value ranges in deriving the second expected outcome; and
selecting, from the plurality of value ranges, the target value range having a measure of contribution exceeding a further contribution threshold.

16. The system of claim 12, wherein determining the target value range comprises:
providing a third suggestion of setting a value falling within the target value range for the second target attribute at the second target point by a user; and
providing a fourth suggestion indicating an increase of a weight assigned to the second target attribute in a second prediction model, the second prediction model being used for generating an outcome at the second decision point.

17. A computer program product, the computer program product comprising:
one or more computer readable storage media, and program instructions collectively stored on the one or more computer readable storage media, the program instructions comprising:
program instructions for obtaining process execution data associated with execution of at least one instance of a business process, the business process comprising a plurality of activity points and a plurality of decision points;
program instructions for determining, based on the process execution data, at least one first target attribute available at a first target point subsequent to a first decision point of the plurality of decision points in the business process, the at least one first target attribute having a contribution in deriving a first expected outcome at the first decision point, and the first target point being first activity point or a first decision point; and
program instructions for providing a suggestion of incorporating the at least one first target attribute in decision making at the first decision point executed in a further instance of the business process.

18. The computer program product of claim 17, wherein providing the suggestion of incorporating the at least one first target attribute comprises performing at least one of the following:
providing a first suggestion of provisioning the at least one first target attribute at the first decision point by a user; and
providing a second suggestion of adding the at least one first target attribute as an input to a first prediction model, the first prediction model being used for generating an outcome at the first decision point.

19. The computer program product of claim 17, wherein the program instructions further comprise:
program instructions for identifying a second target point adjacent to a second decision point in the business process, the second target point being a second activity point or a second decision point;
program instructions for determining, based on the process execution data, a target value range of a second target attribute available at the second target point, the second target value range having a contribution in deriving a second expected outcome at the second decision point; and
program instructions for providing a further suggestion of the second target attribute for decision making at the second decision point executed in the further instance of the business process.

20. The computer program product of claim 19, wherein the second decision point has at least one outcome directed to a point preceding the second decision point in the business process.
